(19) United States
(12) Patent Application Publication
(10) Pub. No.: US 2010/0310724 A1
(43) Pub. Date: Dec. 9, 2010

(54) COMPOSITION OF CARBONIC ACID GAS-CONTAINING SOFT JELLY BEVERAGE IN AN AIRTIGHT CONTAINER AND A METHOD FOR PRODUCING THE SAME

(76) Inventors: Eiji Nakata, Tokyo (JP); Yukimi Yamakawa, Tokyo (JP); Masaharu Sahashi, Gifu Prefecture (JP); Akinori Hosoe, Gifu Prefecture (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/741,578

(22) PCT Filed: Nov. 5, 2008
(86) PCT No.: PCT/IB2008/003781

§ 371 Date: Aug. 23, 2010

(30) Foreign Application Priority Data
Nov. 6, 2007 (JP) 2007 288148

(51) Int. Cl. A23L 1/06; A23L 1/0532; A23L 1/304; A23L 1/0524; A23L 1/0526; A23L 2/52; A23L 2/54; A23L 1/054

(52) U.S. Cl. 426/74; 426/575; 426/577

(57) ABSTRACT

To provide a composition and a method for producing a carbonic acid gas-containing soft jelly beverage in an airtight container suitable for drinking by pouring the beverage from the container after gently shaking the container several times to break the jelly product or for sucking through a drinking straw inserted in the container. Mixing 0.3% (w/v) or less (total amount) of a gelatinizer containing kappa carrageenan in an amount of 0.001% (w/v) or more to less than 0.035% (w/v) to a beverage stock, adding a carbonate to the resultant mixture, charging a container with the carbonic acid gas-containing liquid mixture, subjecting the container to a heat treatment of 700 C to 800 C for 10 to 20 minutes to melt and dissolve the gelatinizer, stirring the liquid mixture having the gelatinizer melted and dissolved therein to a homogeneous state, and cooling the mixture.

### CLAIM OF PRIORITY

This International PCT application claims the right and benefit of priority to Japan Application No. Patent Application No. 2007-288148, filed Nov. 6, 2007, the entire content of which is incorporated herein by reference.

### TECHNICAL FIELD

A method for producing a carbonic acid gas-containing soft jelly beverage in an airtight container prepared by adding carbonic acid gas to a soft jelly beverage (hereinafter referred to as “soft jelly beverage”) composed of a predetermined gelatinizer and a beverage stock, thereby allowing the beverage to absorb carbonic acid gas is provided herein. Also, disclosed herein are a composition and a method for producing a carbonic acid gas-containing soft jelly beverage in an airtight container suitable for drinking by pouring the beverage from the container after gently shaking the container several times to break the jelly product or for sucking through a drinking straw inserted in the container.

### BACKGROUND

A carbonic acid gas-containing beverage of a carbonic acid gas-containing beverage with jelly pieces, or chips added thereto is a well known commercial product.

Recently, preferences as to food have changed in various ways. With this change, people who get tired of conventional food and drink are likely to seek new-style foods and beverages. This tendency is particularly and increasingly seen in young people. In accordance with that tendency, newstyle beverages in airtight containers such as cans and cups have been launched on the market.

Japanese Patent Application No. 2001-021300 is directed to providing a novel and delicious soft jelly beverage distinguishable from conventional ones, so as to satisfy such a tendency in the field of carbonic acid gas-containing beverages in an airtight container. To attain the object, the publication discloses a method for producing a carbonic acid gas-containing soft jelly beverage, characterized by the steps of combining easy-to-soluble agar, xanthan gum, locust bean gum, a sugar and an organic acid to prepare a jelly product, cutting the jelly product into small pieces, charging a container with the jelly pieces and a carbonic acid gas-containing syrup composed of a syrup, a sugar and an acidulent and absorbing carbonic acid gas, sealing the container, applying a heat treatment to the container to melt and dissolve the jelly product, stirring the melted and dissolved jelly product and the syrup to a homogeneous state, and cooling the homogeneous mixture.

The carbonic acid gas-containing soft jelly beverage produced by this method has a soft jelly content aggregated as a whole in an airtight container such as a can. The jelly product can be sucked through a drinking straw inserted in the container or by drinking the jelly product by gently shaking the container to break the jelly product within the container and opening the container. However, this method has a step of melting a gelatinizer, such as agar, at a temperature as high as 85° C. to 90° C. after a container is charged with a carbonic acid gas-containing beverage and sealed. If the airtight container having a carbonic acid gas-containing beverage charged and sealed is heated at such a high temperature, the inner pressure increases, causing buckling. To avoid the buckling risk, the heat treatment must be performed in hot water under pressure by retort heating while externally apply pressure so as to keep balance between inner pressure and exterior pressure. In producing such a beverage industrially, a conventional production line presently in use for producing a carbonated beverage using a pasteurizer as a heating apparatus cannot be used as it is. More specifically, a retort apparatus (with hot water under pressure) must be added to the conventional carbonated beverage production line presently in use. Hence, this method has a problem of high manufacturing cost.

The aforementioned method requires a step of cutting a jelly product serving as a gelatinizer into uniform cubic pieces of about 5 mm squares. In addition, another step must be separately performed for adding a carbonate into a syrup/water mixture by a carbonator, and then, charging a container with the cubic gelatinizer pieces. Therefore, the production process becomes complicated and has a problem of high manufacturing cost.

Japanese Patent No. 2658008 discloses a method for producing a carbonic acid gas-containing jelly beverage, comprising the steps of uniformly dispersing kappa carrageenan (insoluble in cold water) and/or iota carrageenan in an aqueous solution, adding carbonic acid gas into the liquid mixture, charging a container with the mixture, sealing the container, sterilizing the content with heat, and cooling it. However, according to this method, after a gelatinizer is dispersed in an aqueous solution and carbonic acid gas is added, a pressure resistant glass bottle is charged with the resultant mixture. Sterilization is performed by heating the bottle in warm water (85° C.) for 20 minutes (Example 1) or showering the bottle with warm-water (90° C.) for 15 minutes (Example 2). A pressure resistant glass bottle can withstand the heat-sterilization temperature conditions; however, a food can may cause buckling as mentioned above. To overcome the buckling risk, retort must be performed in hot water under pressure. Therefore, a conventional production line presently in use for producing a carbonated beverage using a pasteurizer cannot be used as is. Furthermore, this method requires use of kappa carrageenan and/or iota carrageenan in an amount of 0.3 to 2.0 wt % as a gelatinizer (Claim 2 and Tables 1 and 2). From this, it is considered that the total amount of gelatinizers (containing another type of gelatinizer) must be 0.3% or more. However, a jelly beverage produced by this method is extremely hard. A person can eat the jelly beverage by spoon but cannot drink it even if a person gently shakes a container such as a food can or a paper cup to break the jelly product into pieces and opens the container to drink. This is because the jelly product is separated from the container wall by shaking but cannot be broken into pieces. For the same reason, a person cannot drink the jelly by sucking it through a drinking straw inserted in the container.

Accordingly, this method is not suitable for producing a carbonic acid gas-containing soft jelly beverage in an airtight container suitable for drinking by pouring the beverage from the airtight container after gently shaking the container several times to break the jelly product or for sucking through a drinking straw inserted in the container.

Furthermore, Japanese Patent Application Laid-Open No. 2007-236299 discloses a method for producing a carbonic acid gas-containing soft jelly beverage, which comprises the steps of preparing a gelatinizer primarily containing kappa carrageenan (0.05 to 0.15% by mass based on the total amount of the beverage) and locust bean gum (0.08 to 0.20% by mass based on the total amount of the beverage) having a melting temperature of 70° C. to 80° C., mixing the gelatinizer with a beverage stock, adding a carbonate to the resultant mixture, charging a container with the carbonic acid gas-containing mixture, sealing the container, applying a heat treatment to the container at 70° C. to 80° C. for 10 to 20 minutes to melt and dissolve the gelatinizer, stirring the liquid mixture having the gelatinizer melted and dissolved therein to a homogeneous state, and cooling it. According to this method, since the gelatinizer primarily contains kappa carrageenan having a melting temperature within the range of 70° C. to 80° C. and locust beam gum capable of melting within the temperature range, the gelatinizer can be melted and dissolved in the beverage by applying a heat treatment of 70° C. to 80° C. after a container is charged with the carbonic acid gas-containing liquid mixture and sealed. By virtue of this, a retort apparatus is not required. Therefore, a conventional production line presently in use for producing a carbonated beverage using a pasteurizer as a heating apparatus can be used. Since a production process can be simplified in this way, manufacturing cost can be reduced.

A person can drink the jelly product produced by this method by sucking it through a drinking straw inserted in the container. In an attempt to drink it by gently shaking a container, such as a food can or a paper cup, several times to break the jelly product into pieces and opening the container, However, the jelly product cannot smoothly come out from the container. The jelly product must be pushed out by applying pressure to the container. Accordingly, this method is not satisfactory for producing a carbonic acid gas-containing soft jelly beverage in an airtight container suitable for drinking by pouring the beverage from the airtight container after gently shaking the container several times to break the jelly product.

### SUMMARY

The embodiments presented herein have been disclosed with the view to overcome the problems of the conventional techniques associated with the aforementioned methods. A composition and method suitable for producing a carbonic acid gas-containing soft jelly beverage in an airtight container suitable for drinking by pouring the beverage from the container after gently shaking the container several times to break the jelly product or for sucking through a drinking straw inserted in the container is provided herein. The beverage maintains sufficient taste and texture as a carbonic acid gas-containing soft jelly beverage, and produced by using a conventional carbonated beverage production line presently in use without providing a retort apparatus and in a simple production process, since a step of cutting the gelatinizer into cubic pieces is not required.

A composition and method suitable for producing a carbonic acid gas-containing soft jelly beverage in an airtight container for drinking by pouring the beverage from the container after gently shaking the container several times to break the jelly product or for sucking through a drinking straw inserted in the container is provided. The method may include using a gelatinizer (contained in an extremely small amount of 0.3% or less in total) containing kappa carrageenan in an amount of 0.001% w/v or more to less than 0.035% w/v, and charging a container with a carbonic acid gas-containing beverage, sealing, melting, and subjecting to a heat treatment at 70° C. to 80° C. to melt and dissolve the gelatinizer.

According to one embodiment, there is provided a composition of carbonic acid gas-containing soft jelly beverage and food characterized in that the use amount of kappa carrageenan is 0.001% w/v or more to less than 0.035% w/v and the total use amount of a gelatinizer is less than 0.3%.

According to another embodiment, there is provided a composition of a carbonic acid gas-containing soft jelly beverage or food characterized by comprising a potassium salt and a calcium salt as mineral.

According to yet another embodiment, there is provided a composition of a carbonic acid gas-containing soft jelly beverage or food, characterized in that the gelatinizer is composed of one of or a combination of two or more types of pectin, locust bean gum, xanthan gum, guar gum, konjak mannan, tamarind gum and CMC other than kappa carrageenan.

According to yet another embodiment there is provided a method for producing a carbonic acid gas-containing soft jelly beverage or food in an airtight container, characterized by preparing a stock liquid in accordance with a composition disclosed herein, adding carbonic acid gas into the stock liquid before or after charging a container with the stock liquid, applying a heat treatment to the container charged with the stock liquid at 70° C. to 80° C. for 10 to 20 minutes to melt and dissolve a gelatinizer, stirring a liquid mixture having the gelatinizer melted and dissolved therein to a homogeneous state and cooling the mixture.

### BRIEF DESCRIPTION OF THE DRAWING

FIG. 1 depicts a flowchart of an embodiment disclosed herein.

### DESCRIPTION OF THE EMBODIMENTS

As described above, the present inventors conducted studies focusing upon combination of gelatinizers, total use amount thereof and a key factor, the content of kappa carrageenan.

According to an embodiment, it is possible to provide a composition and method suitable for producing a carbonic acid gas-containing soft jelly beverage in an airtight container suitable for drinking (hereinafter, referred to as “shake-drinking use”) by pouring the beverage from the airtight container after gently shaking the container several times to break the jelly product or for sucking (hereinafter, referred to as “straw-drinking use”) the beverage through a drinking straw inserted in the container, by using a gelatinizer (contained in an amount of 0.3% or less in total) containing kappa carrageenan in an amount of 0.001% w/v or more to less than 0.035% w/v, and charging a container with a carbonic acid gas-containing beverage, sealing, melting and subjecting to a heat treatment at 70° C. to 80° C. to melt and dissolve the gelatinizer.

The gelatinizer primarily contains kappa carrageenan having a melting temperature of 70° C. to 80° C. Therefore, the gelatinizer can be melted and dissolved in a beverage by applying a heat treatment ranging from 70° C. to 80° C. after charging a container with a carbonic acid gas-containing liquid mixture and sealing it. By virtue of this, a retort apparatus is not required and a conventional carbonated beverage production line presently in use using a pasteurizer as a heating apparatus can be used. In addition, since the production process can be simplified, manufacturing costs can be reduced.

Furthermore, the gelatinizer is mixed in powder form with a beverage stock and the gelatinizer (after gelatinized) is not cut into cubic pieces. By virtue of this, it is not necessary to separately perform a step for cutting the gelatinizer (after gelatinized) into cubic pieces. Since the production process can be simplified in this way, manufacturing costs can be further reduced.

### Gelatinizer

One of the features of the compositions and methods disclosed herein resides in use of a gelatinizer primarily containing kappa carrageenan in an amount of 0.001% w/v or more to less than 0.035% w/v.

As a carrageenan, lambda and iota carrageenan are known other than kappa carrageenan. The random carrageenan does not melt by a heat treatment performed at 70° C. to 80° C. The iota carrageenan does not form a stiff jelly product and therefore is not appropriate. It was found that the gelatinizer limited to kappa carrageenan since it melts by heat treatment of 70° C. to 80° C. and gelatinizes to form a suitable jelly product.

It was found that the use amount of kappa carrageenan is critical and limited within an extremely narrow range from 0.001% w/v to less than 0.035% w/v. When the use amount of kappa carrageenan is less than 0.001% w/v, gelatinization is sufficient. Conversely, when the use amount is 0.035% w/v or more, the state of soft jelly beverage is sufficient for straw-drinking use, more specifically, suitable for sucking through a drinking straw inserted therein; however, that amount of kappa carrageenan is not suitable for shakedrinking use since the jelly product is not sufficiently broken even if a container is shaken 5 times or more, with the results that the jelly does not smoothly come out from the container and must be pushed out by applying pressure to the container. In another embodiment, the amount of kappa carrageenan ranges from 0.005 to less than 0.035% w/v. In a further embodiment, the amount of kappa carrageenan ranges from 0.01 to 0.03% w/v.

According to the production method disclosed herein, the gelatinizer is composed of one of or a combination of two or more types of pectin, locust bean gum, xanthan gum, guar gum, konjak mannan, tamarind gum and CMC other than kappa carrageenan.

There are many types of locust bean gums capable of melting at 70° C. to 80° C. Commercially available highly purified locust bean gum is suitable since it is easily obtained.

Xanthan gum is preferably added since it improves the texture of a beverage and melts at 70° C. to 80° C.

The amount of a gelatinizer other than kappa carrageenan used herein may vary. Locust beam gum is preferably used in an amount of 0.04% w/v to 0.08% w/v based on the total amount of the beverage. Xanthan gum is preferably used in an amount of 0.04% w/v to 0.08% w/v based on the total amount of the beverage. When the use amount of a gelatinizer is less than the lower limit, sufficient gelatinization cannot be performed. On the other hand, when the use amount exceeds the upper limit, the hardness of a jelly product increases, with the result that it may be difficult for the jelly to come out from a container in the case of shake-drinking use and the texture deteriorates.

Another feature disclosed herein resides in that carbonic acid gas-containing soft jelly beverage suitable for shake-drinking use and straw-drinking use can be produced by limiting the uppermost value of the total use amount of a gelatinizer, more specifically, suppressing the total use amount of the gelatinizer within less than 0.3% w/v. When the total use amount of a gelatinizer is 0.3% or more, a jelly product can separate from the container wall by shaking a container for shake-drinking use several times; however, the jelly product fails to break into small pieces. Also, in the case of straw-drinking use, a jelly product cannot come out smoothly by sucking it by a drinking straw. Accordingly, when the total use amount of a gelatinizer is 0.3% w/v or more the beverage is not suitable for either shake-drinking use or straw-drinking use.

### Beverage Stock

In the production method disclosed herein, a heat treatment is applied to a beverage container at 70° C. to 80° C. for 10 to 20 minutes after the container is charged and sealed. Therefore, the beverage stock to be used in the carbonic acid gas-containing soft jelly beverage presently disclosed must be sterilized within the aforementioned temperature range. Accordingly, a beverage stock satisfying the condition is preferred to be relatively low acidic having pH of 3.3 to 3.8. Examples of the beverage stocks include fruit juices such as blueberry, lemon, grapefruit, Japanese apricot, peach, pineapple, grape, bilberry, pear, mango, acerola, Kirkham, banana, orange and lychee; and nonfruit juices such as cola, coffee, tea, honey (honey lemon), lactic acid beverage, fermented soybean milk and green tea beverage.

### Potassium Salt

In the production methods disclosed herein, a potassium salt may be contained in at least one of a gelatinizer and a beverage stock.

A monovalent cation is required to harden the melted and dissolved kappa carrageenan into a gel state. Therefore, it is preferable to use a convenient potassium salt, which is commercially available and free from taste and safety issues. Potassium salts that have been approved as food additives are preferably used. Specific examples thereof include, but are not limited to, potassium chloride, potassium monophosphate, potassium diphosphate, potassium triphosphate, potassium carbonate, potassium hydrogentartrate, potassium pyrophosphate, and potassium polyphosphate.

The amount of a potassium salt used preferably falls within the range of 10 to 12 mmol/l based on the total amount of the beverage. When the amount of a potassium salt is less than the lower limit, kappa carrageenan may not be sufficiently gelatinized. In contrast, when the amount exceeds the upper limit, the hardness of a jelly product increases, with the result that the jelly may not come out from a container for shaking drink use. In addition, salty taste increases and mineral odor increases, affecting texture.

### Calcium Salt

Similarly, a calcium salt is preferably used in order to harden xanthan gum into a gel state by heating. As an example of the calcium salt that has been approved to be indicated as a food additive, calcium lactate may be mentioned.

The use amount of a calcium salt preferably falls within the range of 3 to 10 mmol/l based on the total amount of the beverage. When the use amount of a calcium salt is less than the lower limit, xanthan gum may not be sufficiently gelatinized. In contrast, when the use amount exceeds the upper limit, the hardness of a jelly product increases, with the result that the jelly may not come out from a container for shaking drink use. In addition, mineral odor increases, affecting texture.

### Other Components

When a fruit juice is used as a beverage stock, it is preferable to add a sugar serving as a sweetener and an organic acid serving as an acidulant in order to provide a tasty carbonic acid gas-containing beverage. As the sugar, fructose/glucose liquid is particularly preferable. As the organic acid, citric acid is particularly preferable.

Sodium citrate may be added for controlling pH. Flavor and the like can be appropriately added to control other features of a beverage such as taste and texture. When a non-fruit juice such as tea or coffee is used as a beverage stock, additives such as a pH controller, emulsifier and vitamin can be appropriately added in accordance with the type of beverage.

The amounts of these components to be added to a beverage stock other than a gelatinizer may differ depending upon the type of beverage and a desired pH to be controlled.

### Preparation of Carbonic Acid Gas-Containing Liquid Mixture

A beverage stock is prepared from a beverage base such as a fruit juice by adding optional additives such as a sugar and an acidulant. On the other hand, pure water is treated by a deaerator to remove extra gas components contained in the pure water. Thereafter, the beverage stock and pure water are mixed in an arbitrary mixing ratio. A gelatinizer may be added to the beverage stock in the form of powder before the beverage. Stock is mixed with pure water or may be added to the liquid mixture after mixing them. The gelatinizer added is swollen with water and scattered in the liquid mixture. When a carbonated beverage production line presently in use is employed, carbonate is added to the liquid mixture by a carbonator provided on the line to prepare a carbonic acid gas-containing liquid mixture. When a method other than the carbonated beverage production line is used, carbonic acid gas is added to the pure water prepared by the aforementioned method by a carbonator or the like to prepare carbonated water. The carbonated water is mixed with the beverage stock in an arbitrary ratio to prepare a carbonic acid gas-containing liquid mixture. When carbonic acid gas is preferably added to a liquid by a carbonator or the like, the liquid is preferably cooled to 4° C. or less in order to avoid foaming that occurs when carbonate dissolves and low dissolution of carbonic acid gas. Furthermore, carbonic acid gas may be added to the beverage stock contained in a container.

### Heat Treatment and Stirring/Homogenous Treatment

Next, a container such as a cup or a food can is charged with the carbonic acid gas-containing liquid mixture thus prepared, sealed, and heated by a pasteurizer at 70° C. to 80° C. for 10 to 20 minutes. In this manner, a gelatinizer is melted and dissolved in the liquid mixture; at the same time, the requisite sterilization is performed. Subsequently, to homogenize the liquid, for example, the container is rotated on the line, 1 to 5 rounds, like a screw, to mix the melted and dissolved gelatinizer and the beverage stock in the container to a homogenous state. After that, the container is cooled with water or the like to 20° C. or less to obtain a soft jelly beverage product.

### A Carbonated Beverage Production Line

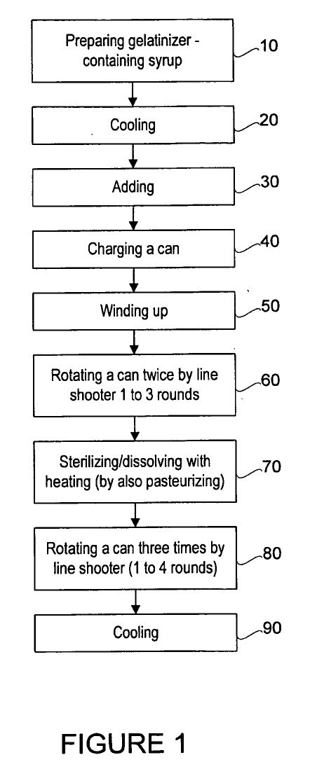

Referring to the accompanying FIG. 1, an embodiment for producing a soft jelly beverage from a fruit juice as a beverage stock by a carbonated beverage production line presently in use is provided.

As shown in the flowchart of FIG. 1, a syrup mixture is prepared 10 by adding a powdery gelatinizer to a beverage stock containing a fruit juice serving as a base, a sugar and additives such as an acidulant, and stirring them at 20° C. The syrup mixture is filtrated by a filter of e.g., #60 in size; on the other hand, pure water is treated by a deaerator to remove extra gas components. The syrup mixture and the pure water are mixed in a predetermined ratio by a synchro-mixer equipped with a measurer.

After the resultant liquid mixture is cooled 20 to 4° C., the mixture is fed to a carbonator to add carbonic acid gas 30 to the liquid mixture (the volume ratio of gas to a product corresponds to 20).

Subsequently, a can is charged 40 with the carbonic acid gas-containing liquid mixture and wound up 50. Thereafter, the can is rotated on the line, like a screw, 1 to 3 rounds, to diffuse the carbonic acid gas into the gelatinizer 60.

After that, the liquid mixture is fed to a pasteurizer 70, heated at 75° C. for 10 minutes to melt and dissolve the gelatinizer; at the same time the mixture is sterilized.

To homogenize the liquid in the can, the can is rotated on the line, 1 to 4 rounds, like a screw 80, and then, cooled 90 to 20° C. or less to obtain a product.

### EXAMPLES

Examples and Comparative examples will be explained below.

### Formulation

Various experiments were performed to investigate an adequate amount range of kappa carrageenan as a main component of a gelatinizer to be used in the method of the present invention and an adequate range of total use amount of the gelatinizer. Preferable formulations thus obtained are shown as Examples in Table 1 below together with Comparative Examples.

TABLE 1

| | | | Comparative | Comparative | Comparative |
|---|---|---|---|---|---|
| | Example 1 | Example 2 | Example 1 | Example 2 | Example 3 |
| Component | (% w/v) | (% w/v) | (% w/v) | (% w/v) | (% w/v) |
| Kappa carrageenan | 0.03 | 0.03 | 0.05 | 0.1 | 0.148 |
| Locust bean gun | 0.056 | 0.130 | 0.056 | 0.056 | 0.0829 |
| Xanthan gum | 0.0476 | — | 0.0476 | 0.0476 | 0.0705 |
| ⅙ orange juice | 1.67 | 1.67 | 1.67 | 1.67 | 1.67 |
| Citric acid | 0.31 | 0.31 | 0.31 | 0.31 | 0.31 |
| Sodium citrate | 0.148 | 0.148 | 0.148 | 0.148 | 0.148 |
| Calcium lactate | 0.148 | 0.148 | 0.148 | 0.148 | 0.148 |
| Potassium dihydrogen phosphate | 0.2 | 0.2 | 0.2 | 0.2 | 0.2 |
| Fructose/glucose liquid | 21.675 | 21.675 | 21.675 | 21.675 | 21.675 |
| Gelatinizer (total amount) | 0.1336 | 0.160 | 0.1536 | 0.2036 | 0.3014 |

### Procedure

(1) All gelatinizers were dispersed in pure water.

(2) Other components were separately dispersed and dissolved.

(3) The gelatinizers dispersed and other components were combined and stirred.

(4) Carbonic acid gas was added to the liquid mixture of (3) and loaded in an aluminum can.

(5) The can was wound up and sealed.

(6) The can was heated at 70° C. to 80° C. for 10 to 20 minutes.

(7) The can was rotated to homogenize the liquid mixture.

(8) The can was then cooled with water.

(9) The can cooled with water was allowed to leave at room temperature for 28 hours and cooled to about 20° C. for 2 hours before use. A panel test was performed by opening the can.

### Results

### Example 1

### Kappa Carrageenan: 0.03% (w/v)

The jelly liquid content came out smoothly just by shaking a can vertically about 5 times. The beverage had a sufficiently characteristic texture to a jelly beverage and refreshing taste characteristic to carbonic acid gas.

The pH of the jelly beverage was 3.55, and the Brix value was 15.9.

### Example 2

### Kappa Carrageenan: 0.03% (w/v)

The jelly liquid content came out smoothly just by shaking a can vertically about 5 times. The beverage had a sufficiently characteristic texture to a jelly beverage and refreshing taste characteristic to carbonic acid gas.

The pH of the jelly beverage was 3.55, and the Brix value was 16.7.

### Comparative Example 1

### Kappa Carrageenan: 0.05° A) (w/v)

The jelly liquid content did not come out smoothly from a can even through the can was shaken 5 times or more but came out by gently pushing the can several times. Any serious problems as a jelly beverage were not found in the texture of the beverage. This is desirable for straw-drinking use.

The pH of the jelly beverage was 3.52, and the Brix value was 16.7.

### Comparative Example 2

### Kappa Carrageenan: 0.1% (w/v)

The jelly liquid content did not come out even through the can was shaken 5 times or more. The jelly liquid content came out by applying external force after the can was shaken 10 times or more. The texture of the jelly beverage is brittle and thus slightly poor. This product conceivably finds use only in straw-drinking use, as a merchandise product.

The pH of the jelly beverage was 3.52, and the Brix value was 16.8.

### Comparative Example 3

### Kappa Carrageenan: 0.3% (w/v)

The jelly liquid content was separated from a can wall by shaking the can. However the content did not break into small pieces. The texture was not like a soft jelly beverage but like a food suitable for eating by spoon. It may be difficult to suck it through a drinking straw.

The pH of the jelly beverage was 3.52, and the Brix value was 17.0.

### Panel Test

The carbonic acid gas-containing soft jelly beverages of Examples 1 and 2 and Comparative Examples 1 to 3 were evaluated by 6 to 11 panelists. The panelists tasted a beverage four times and comprehensively evaluated it with respect to qualities including smoothness of the content in coming out from a can and texture. Evaluation was performed at 5 levels: excellent, good, acceptable, unfavorable, bad. The results are, as follows, in Tables 2-6.

TABLE 2

| | Number of panelists | | |
|---|---|---|---|
| | Male | Female | Total |
| First time | 2 | 4 | 6 |
| Second time | 5 | 6 | 11 |
| Third time | 4 | 0 | 4 |
| Fourth time | 2 | 6 | 8 |
| Average | 3.25 | 4 | 7.25 |

[Unit of the numeric values is the number of persons.]

TABLE 3

| | | | | Accept- | Unfavor- | |
|---|---|---|---|---|---|---|
| Evaluation | | Excellent | Good | able | able | Bad |
| First time | Example 1 | 5 | 1 | 0 | 0 | 0 |
| | Example 2 | 5 | 1 | 0 | 0 | 0 |
| | Comparative | 1 | 1 | 3 | 1 | 0 |
| | Example 1 | | | | | |
| | Comparative | 0 | 1 | 1 | 3 | 1 |
| | Example 2 | | | | | |
| | Comparative | 0 | 0 | 0 | 3 | 3 |
| | Example 3 | | | | | |
| Second | Example 1 | 8 | 2 | 1 | 0 | 0 |
| | Example 2 | 7 | 3 | 1 | 0 | 0 |
| | Comparative | 2 | 3 | 4 | 1 | 1 |
| | Example 1 | | | | | |
| | Comparative | 0 | 0 | 3 | 7 | 1 |
| | Example 2 | | | | | |
| | Comparative | 0 | 0 | 1 | 4 | 6 |
| | Example 3 | | | | | |
| Third time | Example 1 | 3 | 1 | 0 | 0 | 0 |
| | Example 2 | 2 | 2 | 0 | 0 | 0 |
| | Comparative | 1 | 1 | 2 | 1 | 0 |
| | Example 1 | | | | | |
| | Comparative | 0 | 0 | 1 | 3 | 0 |
| | Example 2 | | | | | |
| | Comparative | 0 | 0 | 0 | 1 | 3 |
| | Example 3 | | | | | |
| Fourth | Example 1 | 6 | 2 | 0 | 0 | 0 |
| | Example 2 | 6 | 2 | 0 | 0 | 0 |
| | Comparative | 2 | 3 | 1 | 2 | 0 |
| | Example 1 | | | | | |
| | Comparative | 0 | 1 | 4 | 2 | 1 |
| | Example 2 | | | | | |
| | Comparative | 0 | 0 | 1 | 3 | 4 |
| | Example 3 | | | | | |

[Unit of the numeric values is the number of persons.]

TABLE 4

| Average | | | Accept- | Unfavor- | |
|---|---|---|---|---|---|
| (persons) | Excellent | Good | able | able | Bad |
| Example 1 | 5.5 | 1.5 | 0.25 | 0 | 0 |
| Example 2 | 5.0 | 2.0 | 0.25 | 0 | 0 |
| Comparative | 1.25 | 2.0 | 2.5 | 1.25 | 0.25 |
| Example 1 | | | | | |
| Comparative | 0 | 0.5 | 2.25 | 3.75 | 0.75 |
| Example 2 | | | | | |
| Comparative | 0 | 0 | 0.5 | 2.75 | 4.0 |
| Example 3 | | | | | |

TABLE 5

| | | | Accept- | Unfavor- | |
|---|---|---|---|---|---|
| Average (%) | Excellent | Good | able | able | Bad |
| Example 1 | 76% | 21% | 3% | 0% | 0% |
| Example 2 | 69% | 28% | 3% | 0% | 0% |
| Comparative | 17% | 28% | 34% | 17% | 3% |
| Example 1 | | | | | |
| Comparative | 0% | 7% | 31% | 52% | 10% |
| Example 2 | | | | | |
| Comparative | 0% | 0% | 7% | 38% | 55% |
| Example 3 | | | | | |

Points 5, 4, 3, 2 and 1 were respectively given to excellent, good, acceptable, unfavorable and bad, and scores were calculated by multiplying the number of persons. The larger the score, the higher the evaluation.

TABLE 6

| | | | Accept- | Unfavor- | | |
|---|---|---|---|---|---|---|
| | Excellent | Good | able | able | Bad | Total |
| Example 1 | 28 | 6 | 1 | 0 | 0 | 34 |
| Example 2 | 25 | 8 | 1 | 0 | 0 | 34 |
| Comparative | 6 | 8 | 8 | 3 | 0 | 25 |
| Example 1 | | | | | | |
| Comparative | 0 | 2 | 7 | 8 | 1 | 17 |
| Example 2 | | | | | | |
| Comparative | 0 | 0 | 2 | 6 | 4 | 11 |
| Example 3 | | | | | | |

As is apparent from the results shown above, high evaluations are given to products described in Examples 1 and 2. In other words, when the use amount of kappa carrageenan is less than 0.035% (w/v), good evaluation is conceivably given. Particularly, in the product of shake-drinking use, the uppermost content of kappa carrageenan is considered as 0.035% (w/v). In the product for straw-drinking use, a beverage containing kappa carrageenan in an amount of less than 0.035% (w/v) is conceivably easy to drink.

The total amount of a gelatinizer must be less than 0.3%. If not, a beverage is conceivably not suitable for shake-drinking use and straw-drinking use.

What is claimed is:

1. A composition of a carbonic acid gas-containing soft jelly beverage or food comprising a use amount of kappa carrageenan ranging from 0.001% w/v or more to less than 0.035% w/v, and a total use amount of a gelatinizer is less than 0.3% w/v.

2. The composition according to claim 1, comprising a potassium salt and a calcium salt as mineral.

3. The composition according to claim 1 or 2, wherein the gelatinizer is composed of one of or a combination of two or more types of pectin, locust bean gum, xanthan gum, guar gum, konjak mannan, tamarind gum and CMC other than kappa carrageenan.

4. A method for producing a carbonic acid gas-containing soft jelly beverage or food in an airtight container, characterized by:
preparing a stock liquid in accordance with the composition according to any one of claims 1 to 3,
adding carbonic acid gas into the stock liquid before or after charging a container with the stock liquid,
applying a heat treatment to the container charged with the stock liquid at 70° C. to 80° C. for 10 to 20 minutes to melt and dissolve a gelatinizer,
stirring a liquid mixture having the gelatinizer melted and dissolved therein to a homogeneous state, and
cooling the mixture.
